(19) United States
(12) Patent Application Publication
(10) Pub. No.: US 2020/0143245 A1
(43) Pub. Date: May 7, 2020

(54) NEURAL NETWORK TRAINING METHOD, DEVICE, COMPUTER SYSTEM, AND MOVABLE DEVICE

(71) Applicant: SZ DJI TECHNOLOGY CO., LTD., Shenzhen (CN)

(72) Inventors: Wei PAN, Shenzhen (CN); Jian CUI, Shenzhen (CN); Xiaofan LIN, Shenzhen (CN); Cong ZHAO, Shenzhen (CN)

(21) Appl. No.: 16/697,556

(22) Filed: Nov. 27, 2019

Related U.S. Application Data
(63) Continuation of application No. PCT/CN2017/086547, filed on May 31, 2017.

(51) Int. Cl. G06N 3/08; G06N 3/04; G05D 1/10; G05D 1/00

(52) U.S. Cl. CPC G06N 3/08; G05D 1/0088; G05D 1/101; G06N 3/04

(57) ABSTRACT

An aircraft includes a propulsion system, a sensor system, a control system, and a processing system including a memory and a processor. The memory is configured to store computer-executable instructions. The processor is configured to access the memory and to execute the computer-executable instructions to perform the following steps: obtaining a set of first weights of a processing unit of a neural network; ternarizing each weight included in the set of first weights to obtain a set of second weights; generating an output of the processing unit based on the set of second weights and a set of inputs of the processing unit; and training weights included in the set of first weights of the processing unit of the neural network based on an error cost function including an error term and a structurally sparse term.

### CROSS-REFERENCE TO RELATED APPLICATION

This application is a continuation application of International Application No. PCT/CN2017/086547, filed on May 31, 2017, the entire content of which is incorporated herein by reference.

### COPYRIGHT NOTICE

This patent document contains materials that are subject to copyright protection. The copyright is owned by the copyright owner. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technical field of information technology and, more particularly, to a neural network training method, a device, a computer system, and a movable device.

### BACKGROUND

In a conventional neural network, weights and output of neurons are all real numbers. A neural network may need Giga (10⁹) times of multiplication and addition operations in a forward propagation. As a result, although a large scale neural network can have excellent performance at smart functions, such as object detection, human face recognition, image segmentation, target tracking, semantic segmentation, voice recognition, etc., neural networks are difficult to implement on platforms having limited resources and requiring a low power consumption (e.g., unmanned aerial vehicles, autonomous driving, robots, smart wearable devices, smart home appliances, smart phones, etc.).

On the other hand, advanced computing platform cannot be implemented in consumer products in a large scale due to reasons such as large volume, large power consumption, and huge weight. Compared to the advanced computing platform, the demand from the platform having limited resources for various smart functions is growing larger and larger.

Therefore, how to reduce the resource demand of a neural network has become an emerging technical issue to be addressed.

### SUMMARY

Embodiments of the present disclosure provide a neural network training method, a device, a computer system, and a movable device, which can reduce the resource demand of the neural network.

In accordance with an aspect of the present disclosure, there is provided an aircraft including a propulsion system configured to provide propulsion for the aircraft. The aircraft also includes a control system configured to control movement of the aircraft. The aircraft also includes a processing system including a memory and a processor. The memory is configured to store computer-executable instructions. The processor is configured to access the memory and to execute the computer-executable instructions to perform the following steps: obtaining a set of first weights of a processing unit of a neural network, the processing unit being a convolution core or a neuron; ternarizing each weight included in the set of first weights to obtain a set of second weights; generating an output of the processing unit based on the set of second weights and a set of inputs of the processing unit; and training weights included in the set of first weights of the processing unit of the neural network based on an error cost function. The error cost function includes an error term and a structurally sparse term. The error term relates to an error between an output of a last layer of the neural network and an expected output. The structurally sparse term renders all weights included in the set of first weights of at least one processing unit of the neural network to be zero.

In accordance with another aspect of the present disclosure, there is provided a method for training a neural network. The method includes obtaining a set of first weights of a processing unit of the neural network. The processing unit of the neural network is a convolution core or a neuron. The method also includes ternarizing each weight in the set of first weights to obtain a set of second weight. The method also includes generating an output of the processing unit based on the set of second weights and a set of inputs of the processing unit. The method further includes training weights included in the set of first weights of the processing unit of the neural network based on an error cost function. The error cost function includes an error term and a structurally sparse term. The error term relates to an error between an output of a last layer of the neural network and an expected output. The structurally sparse term renders all weights in the set of first weights of at least one processing unit of the neural network to be zero.

In accordance with another aspect of the present disclosure, there is provided a movable device. The movable device includes a memory configured to store computer-executable instructions. The movable device also includes a processor configured to access the memory and to execute the computer-executable instructions to perform the following steps: obtaining a set of first weights of a processing unit of a neural network, the processing unit being a convolution core or a neuron; ternarizing each weight included in the set of first weights to obtain a set of second weights; generating an output of the processing unit based on the set of second weights and a set of inputs of the processing unit; and training weights included in the set of first weights of the processing unit of the neural network based on an error cost function. The error cost function includes an error term and a structurally sparse term. The error term relates to an error between an output of a last layer of the neural network and an expected output, and the structurally sparse term renders all weights included in the set of first weights of at least one processing unit of the neural network to be zero.

According to the technical solution of the present disclosure, by ternarizing the weights of the neural network and binarizing the activation values, and by introducing a structurally sparse term in an error cost function, the storage amount and the computation amount of the neural network can be significantly reduced while keeping the reduction in the performance of the neural network small, thereby reducing the resource demand of the neural network.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a schematic illustration of a neural network, according to an example embodiment.

FIG. 2 is a schematic diagram of a configuration of the technical solution of the present disclosure, according to an example embodiment.

FIG. 3 is a schematic illustration of a configuration of a movable device, according to an example embodiment.

FIG. 4 is a flow chart illustrating method for training a neural network, according to an example embodiment.

FIG. 5 is a schematic illustration of a plot of a ternary function, according to an example embodiment.

FIG. 6 is a schematic illustration of a plot of a binary function, according to an example embodiment.

FIG. 7 is a schematic illustration of a plot of an activation function, according to an example embodiment.

FIG. 8 is a schematic diagram of a device for training the neural network, according to an example embodiment.

FIG. 9 is a schematic diagram of a computer system, according to an example embodiment.

### DETAILED DESCRIPTION OF THE EMBODIMENTS

Next, the technical solutions of the present disclosure will be described in detail with reference to the accompanying drawings.

It should be understood that the examples in the present disclosure are only for the purpose of assisting a person having ordinary skills in the art in better understanding the embodiments of the present disclosure, and are not intended to limit the scope of the present disclosure.

It should also be understood that the mathematic equations or formulas of the present disclosure are only examples, and are not intended to limit the scope of the present disclosure. Such equations or formulas can be varied. Such variations also fall into the scope of protection of the present disclosure.

It should also be understood that in various embodiments of the present disclosure, the sequence numbers of various processes or steps do not necessarily indicate the order of execution. The order of execution of various processes or steps should be determined by their functions and internal logic, and should not be interpreted as limiting the implementation procedure of the embodiments of the present disclosure.

It should also be understood that various embodiments described in the present disclosure can either be implemented individually, or be implemented in combination, which is not limited by the present disclosure.

The technical solutions of the present disclosure may be implemented in various types of neural networks.

The terms “comprise,” “comprising,” “include,” and the like specify the presence of stated features, steps, operations, elements, and/or components but do not preclude the presence or addition of one or more other features, steps, operations, elements, components, and/or groups. The term “communicatively couple(d)” or “communicatively connect(ed)” indicates that related items are coupled or connected through a communication channel, such as a wired or wireless communication channel. The term “unit,” “sub-unit,” or “module” may encompass a hardware component, a software component, or a combination thereof. For example, a “unit,” “sub-unit,” or “module” may include a housing, a device, a sensor, a processor, an algorithm, a circuit, an electrical or mechanical connector, etc. The term “processor” may include any suitable processor, which may include hardware, software, or a combination thereof. The processor may be a generic processor or a dedicated processor, which may be specially programmed to perform certain functions.

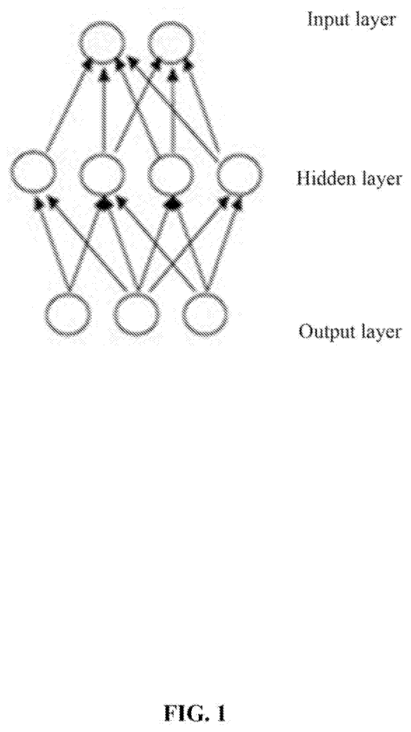

FIG. 1 illustrates a neural network. As shown in FIG. 1, the neural network may include an input layer, one or more hidden layer, and an output layer. The hidden layers in the neural network may all be fully connected layers, or may include a convoluted layer and a fully connected layer. The latter may be referred to as a convolutional neural network.

In the present disclosure, the processing unit of the neural network may be a convolution core or a neuron. In other words, for a convoluted layer, the processing unit may be the convolution core. For the fully connected layer, the processing unit may be the neuron.

To enable a neural network to be implemented on a platform having limited resources, the present disclosure provides a technical solution. According to the technical solution, by ternarizing the weights of the neural network and binarizing the response values (i.e., activation values), the storage amount and the computation amount of the neural network can be significantly reduced. In addition, by introducing a structurally sparse term in an error cost function, weights of some processing units may be zero, thereby further reducing the storage amount and the computation amount.

It should be understood that the technical solution of the present disclosure can not only be implemented in a platform having limited resources, but also in other computing platforms, which is not limited by the present disclosure.

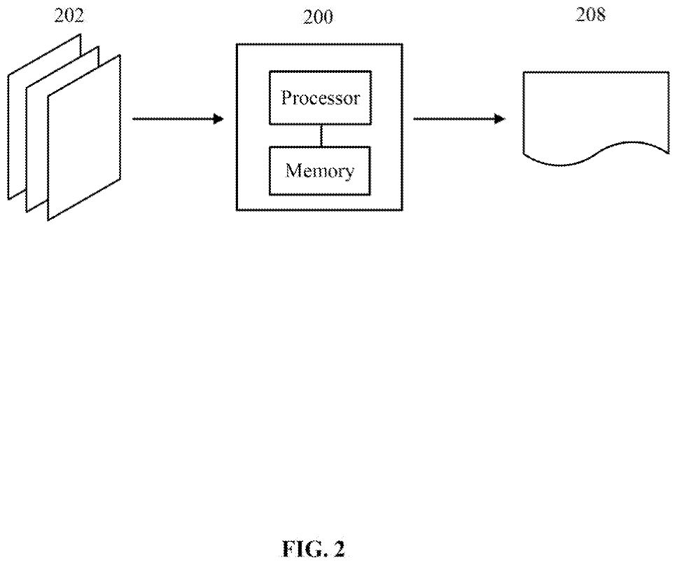

FIG. 2 is a configuration of the technical solution of the present disclosure. A system 200 shown in FIG. 2 may be any platform that implements the neural network.

As shown in FIG. 2, the system 200 may receive input data 202, and process the input data 202 to obtain data 208. In some embodiments, the parts of the system 200 may be realized by one or more processors. The processor may be a processor included in a computing device, or may be a processor included in a movable device (e.g., an unmanned aerial vehicle). The processor may be any type of processor, which is not limited by the present disclosure. In some embodiments, the processor may be a chip formed by various processing circuits. In some embodiments, the system 200 may also include one or more memories. The memory may be configured to store instructions and data, such as the computer-executable instructions configured to realize the technical solution of the present disclosure, and data, etc. The memory may be any suitable type of memory, which is not limited by the present disclosure.

In some designs, the platform having limited resources may be a movable device or a smart device. The movable device may also be referred to as a moving device. The movable device may be an unmanned aerial vehicle (“UAV”), a driverless ship or boat, an autonomous driving vehicle or robot, etc. The smart device may be a smart wearable device, a smart home appliance, a smart cell phone, etc., which is not limited by the present disclosure.

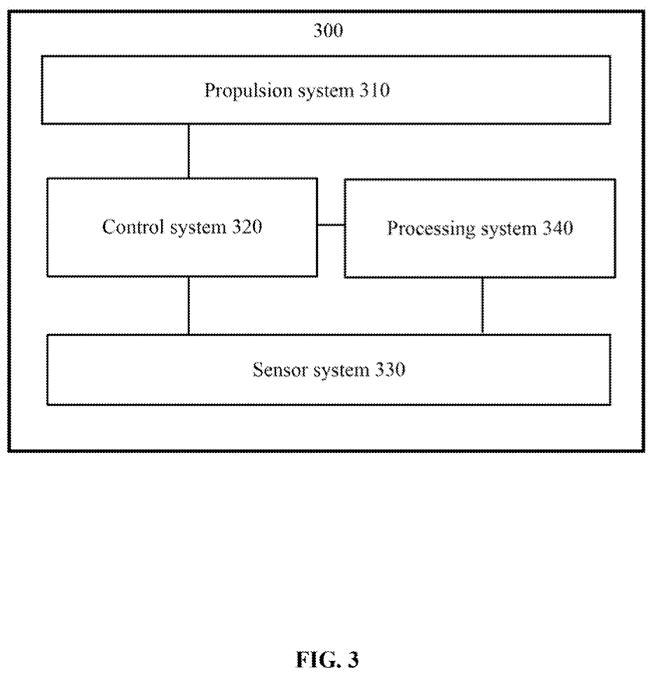

FIG. 3 is a schematic illustration of a configuration of a movable device 300.

As shown in FIG. 3, the movable device 300 may include a propulsion system 310, a control system 320, a sensor system 330, and a processing system 340.

The propulsion system 310 may be configured to provide propulsion for the movable device 300.

Using a UAV as an example, the propulsion system of the UAV may include an electric speed control (or “ESC”), a propeller, and a motor corresponding to the propeller. The motor may be connected between the ESC and the propeller. The motor and the propeller may be disposed on a corresponding arm of the UAV. The ESC may be configured to receive a driving signal generated by the control system 320, and to provide a driving current to the motor based on the driving signal, to control the rotation speed of the motor. The motor may be configured to drive the propeller to rotate, thereby providing the propulsion for the flight of the UAV.

The sensor system 330 may be configured to measure attitude information of the movable device 300, i.e., the location information and status information of the movable device 300 in a space, such as the three-dimensional location, three-dimensional angle, three-dimensional velocity, three-dimensional acceleration, and three-dimensional angular velocity, etc. The sensor system 330 may include at least one of, for example, a gyroscope, a digital compass, an inertial measurement unit (“IMU”), a vision sensor, a global positioning system (“GPS”), a barometer, or an airspeed gauge.

The sensor system 330 may be configured to capture images, i.e., the sensor system 330 may include a sensor for capturing images, such as a camera, etc.

The control system 320 may be configured to control the movement of the movable device 300. The control system 320 may control the movable device 300 based on pre-configured program instructions. For example, the control system 320 may control the movement of the movable device 300 based on the attitude information of the movable device 300 measured by the sensor system 330. The control system 320 may control the movable device 300 based on a control signal from a remote controller. For example, for the UAV, the control system 320 may be the flight control system, or a control circuit in the flight control system.

The processing system 340 may be configured to process the images captured by the sensor system 330. For example, the processing system 340 may include an image signal processing (“ISP”) chip.

The processing system 340 may be the system 200 shown in FIG. 2, or the processing system 340 may include the system 200 shown in FIG. 2.

It should be understood that the division and naming of the various components of the movable device 300 are merely illustrative, and should not be understood to limit the embodiments of the present disclosure.

It should be understood that the movable device 300 may include other components not shown in FIG. 3, which are not limited by the present disclosure.

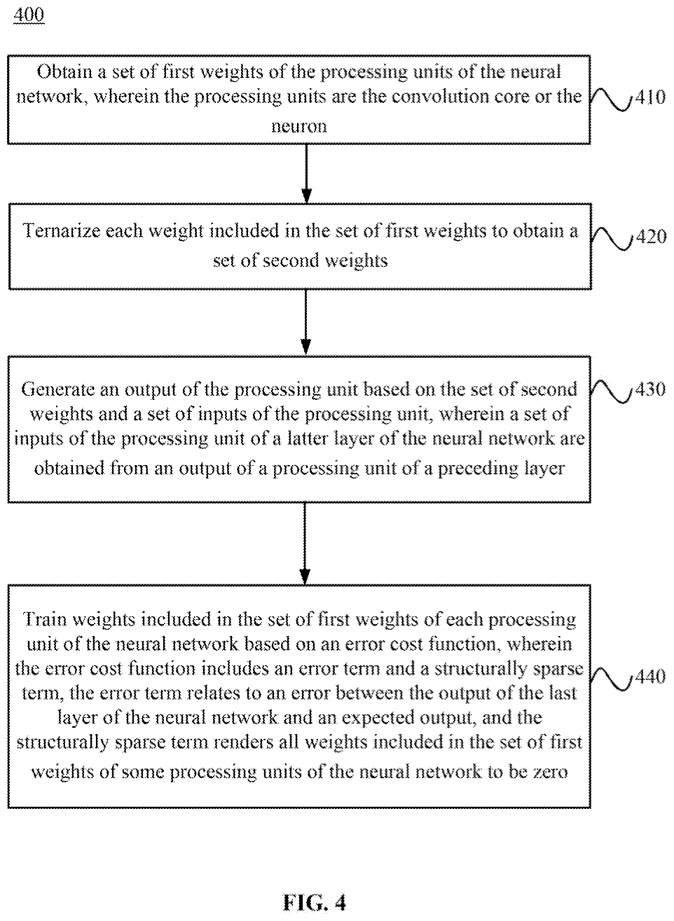

FIG. 4 is a flow chart illustrating a method 400 for training a neural network. The method 400 may be executed by the system 200 shown in FIG. 2, or may be executed by the movable device 300 shown in FIG. 3. Specifically, when executed by the movable device 300, the method 400 may be executed by the processing system 340 shown in FIG. 3.

Step 410: obtaining a set of first weights of the processing units of the neural network, wherein the processing units are the convolution core or the neuron.

The weights included in the set of first weights may be weights to be trained. IN other words, the process of training the neural network may be a process of training the weights included in the set of first weights of each processing unit of the neural network.

The processing unit of the neural network may be the convolution core or neuron. For the convoluted layer, the processing unit is the convolution core. For the fully connected layer, the processing unit is the neuron.

Step 420: ternarizing each weight included in the set of first weights to obtain a set of second weights.

In some embodiments, to reduce the computation amount and the storage amount, the weights may be ternarized. That is, a weight may be assigned one of the three values based on a range of values in which the weight belongs. For example, the three values may be −1, 0, +11.

In some embodiments, if the first weight is in a predetermined range, the first weight may be ternarized to be zero, where the first weight is a weight from the set of first weights.

If the first weight is greater than the predetermined range, the first weight may be ternarized to be 1;

If the first weight is smaller than the predetermined range, the first weight may be ternarized to be −1.

For example, the first weight may be input into the following function (1) to obtain the ternarized weight.

$${T}_{Θ} ( W ) = \{ \begin{matrix}1 , & W \geq Θ \\ 0 , & Θ < W < Θ \\ - 1 , & W \leq - Θ\end{matrix} \qquad ( 1 )$$

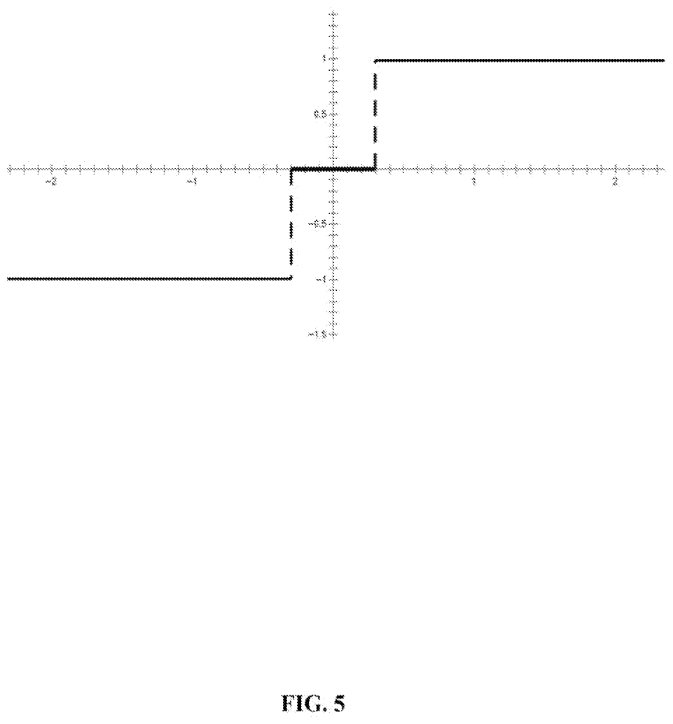

In the above function, W represents the first weight, Θ represents a predetermined value. The predetermined value Θ may be a relatively small positive real number. For example, Θ may be 0.3. A plot of the function T_{θ}(W) is shown in FIG. 5.

The ternarized weights of the weights included in the set of first weights may form the set of second weights.

After being ternarized, the number of digits of the weights can be reduced, therefore, the storage amount for the data can be reduced. Further, the subsequent computation amount can be reduced.

Step 430: generating an output of the processing unit based on the set of second weights and a set of inputs of the processing unit, wherein a set of inputs of a processing unit of a latter layer of the neural network may be obtained from an output of a processing unit of a preceding layer.

In some embodiments, the output may be generated based on the set of second weights (i.e., the set of ternarized weights) and the set of inputs. The set of inputs of the processing unit may be obtained from the output of all the processing units of the preceding layer. For the convolution core of the convoluted layer, the set of inputs may be a set of outputs of the preceding layer corresponding to the convolution core.

In some embodiments, the output of the processing unit may be a binarized value.

In some embodiments, a response value may be obtained based on the set of second weights and the set of inputs of the processing unit. The response value may be binarized to obtain the output of the processing unit.

Specifically, for each processing unit, an inner product may be performed between a vector corresponding to the set of second weights and a vector corresponding to the set of inputs of the processing unit to obtain the response value. The response value may be binarized to obtain the output of the processing unit.

In some embodiments, prior to binarizing the response value, the response value may be processed with a batch normalization to avoid the occurrence of an uncontrollable response value changing range that may affect the convergence of the training.

In some embodiments, the binarizing processing may include assigning one of the values 1 and 0 to the response value.

Specifically, if the response value is greater than a predetermined value, then the output of the processing unit may be processed to be 1; if the response value is not greater than the predetermined value, the output of the processing unit may be processed to be 0.

For example, the response value may be binarized based on the following function (2), to obtain the output of the processing unit.

$$B ( r ) = \{ \begin{matrix}1 , & r > 0.5 \\ 0 , & r \leq 0.5\end{matrix} \qquad ( 2 )$$

In the above function, r represents the response value, B(r) represents the output of the processing unit.

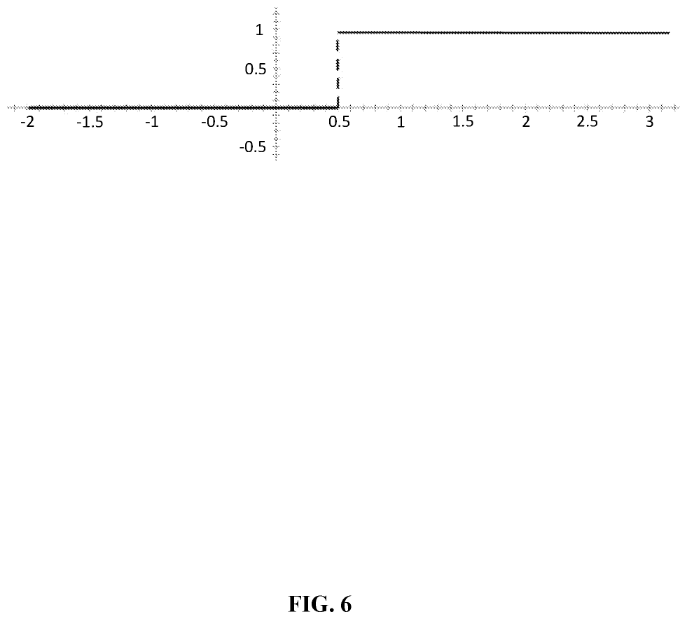

A plot of the function B(r) is shown in FIG. 6.

When binarizing the response value, the binarizing function may be used as an activation function, the output of which may be an activation value.

It should be understood that the activation function and the binarizing function may be simultaneously used. In other words, the response value may be first input into the activation function to obtain an activation value. Then the activation value may be input into a binarizing function to obtain the output of the processing unit. This processing manner can also be implemented in an embodiment of the present disclosure.

Step 440: training weights included in the set of first weights of each processing unit of the neural network based on an error cost function. The error cost function may include an error term and a structurally sparse term. The error term relates to an error between the output of the last layer of the neural network and an expected output. The structurally sparse term renders all weights included in the set of first weights of some processing units of the neural network to be zero.

The process of training the neural network is a process of training the weights included in the set of first weights of each processing unit of the neural network. In some embodiments, the weights included in the set of first weights of each processing unit of the neural network may be adjusted, to render the cost of the error cost function to reach a predetermined cost or to be minimized. During the training, the output of each processing unit may be obtained through the above-described methods.

In some embodiments, in addition to having the error term, the error cost function may also include a structurally sparse term. The error term relates to an error between the output of the last layer of the neural network and an expected output, i.e., the error between the output of the neural network during the training and true values corresponding to the samples. The structurally sparse term may render all weights included in the set of first weights of some processing units of the neural network to be zero.

For example, the error cost function may be the following function (3):

$$C ( W ) = E ( W ) + λ {\sum }_{l = 1}^{L} {\sum }_{{k}_{l} = 1}^{{K}_{l}} ‖ W \text{?} \\ \text{?} \text{indicates text missing or illegible when filed} \qquad ( 3 )$$

In the above function, W represents a vector corresponding to the set of first weights, C represents the error cost function, E represents an error term, F represents a Frobenius norm, L represents the number of layers of the neural network, Kₗ represents the number of convolution cores or neurons of the l-th layer of the neural network, λ, represents a regularized coefficient.

The last term in the function (3) is the structurally sparse term. In this term, the norm of each convolution core or each neuron are added up as a part of the cost. For a convolution core or neuron, this cost will not exist if all of the weights are zero. As such, during the training, the neural network may have the structurally sparse property, i.e., all weights being zero for some processing unit. Therefore, these processing units can be deleted, thereby further reducing the storage amount and the computation amount.

In some embodiments, during the training, a derivative of the error cost function with respect to the second weight may be determined. The first weight may be adjusted based on the derivative. The first weight is a weight from the set of first weights. The second weight is a ternarized value of the first weight before adjustment.

For example, the first weight may be adjusted based on the following equation (4),

$$W = W - η * \frac{\partial c}{\partial wt} \qquad ( 4 )$$

In the above equation, W represents the first weight, wt represents the second weight, C represents the error cost function, η represents the learning speed.

The derivative of step functions such as the binarizing function is zero except at one point where the function is not derivable. As such, the derivation cannot be obtained. Therefore, the derivative may be obtained based on the activation function that has not been binarized. In other words, during the training, the binarizing function is only used in forward broadcast. For back-propagation, derivative may be obtained based on the network structure prior to the binarization.

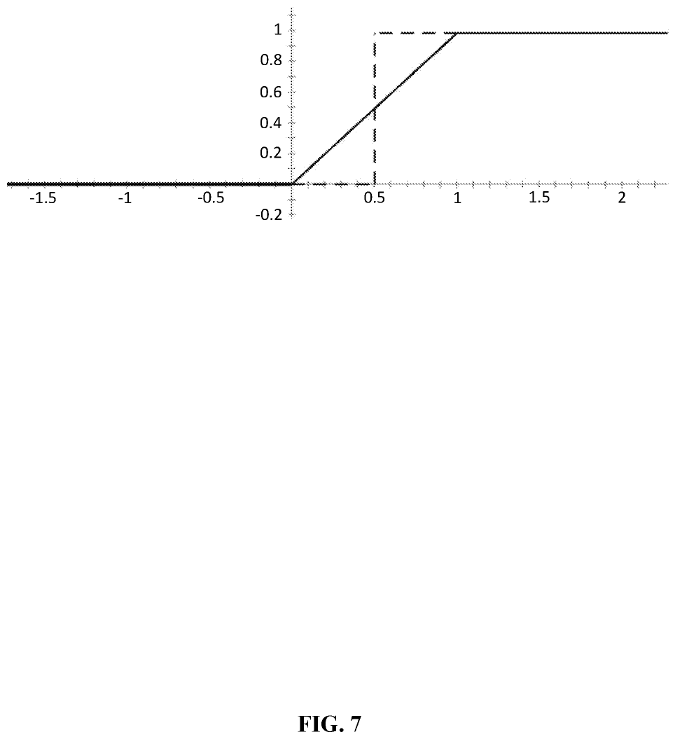

In some embodiments, when back-propagation passes the B(r) function, the derivation may be approximately performed based on the function indicated by the solid line shown in FIG. 7.

In some embodiments, when back-propagation passes the T_{θ}(W) function, the derivation may be performed based on a y=x function. In other words, the T_{θ}(W) function may be ignored in the chain derivation process.

As such, from the approximation perspective, the trained neural network may have excellent performance. A large quantity of storage amount and computation amount may be saved. The cost associated with such approximation may be compensated for by slightly enlarging the size of the neural network. Therefore, the processing of the binarized network in forward propagation can all become bit operation, which can be integrated in dedicated hardware in a large scale, with increased efficiency and reduced consumption of power.

In the technical solution of the present disclosure, by ternarizing the weights of the neural network and binarizing the activation values, and by introducing a structurally sparse term in the error cost function, the storage amount and the computation amount of the neural network can be significantly reduced, under the condition that the performance of the neural network is slightly reduced, thereby reducing the resource demand of the neural network.

In some embodiments, under the condition of ternarizing the weights and binarizing the activation values, the operation in the neural network can be realized through bit operations.

For a weight wϵ{−1,0,+1}, and an activation value aϵ{0,1}, first w may be represented using a two-digit binary number, and a may be represented using a one-digit binary number.

When w is −1, it may be represented by 11, when w is 0, it may be represented by 00, when w is +1, it may be represented by 01. When a is 1, it may be represented by 1, when a is 0, it may be represented by 0. The following is a truth table for the product of w and a.

TABLE 1

| | w = 11 | w = 01 | w = 00 |
|---|---|---|---|
| a = 0 | 00 | 00 | 00 |
| a = 1 | 11 | 01 | 00 |

Most computations in the neural network are scalar product between vectors, which is also referred to as dot product or inner product, i.e., numerical values at corresponding locations in two vectors are multiplied and added up. For two vectors A and W to be processed with scalar product, A may store an activation value (one-digit), W may store a weight (two-digit). That is, a register A (n bits) may store n number of a (activation value). Two registers W1 and W0 (both n bits) may store n number of w (weights). W1 may store higher bit of the weight, and W0 may store lower bit of the weight.

The following method may be used to perform the scalar product between the activation value and the weight. C represents a resulting vector obtained from multiplying the numerical values at corresponding positions in the A vector and the W vector, & represents “bitwise AND.”

(Register for lower) C0=A & W0,

(Register for higher bit) C1=A & W1.

Then, all the numbers included in C are added up, which may also be realized using bit operations.

SUM=bitcount(C0 XOR C1)−bitcount(C0 & C1).

In the above equation, XOR represents “bitwise exclusive OR.” bitcount represents counting how many 1s are included in a register. Most computation platforms support the bitcount operation. SUM is the sum of all elements in the vector C.

As such, n times of multiplication and addition operations may be accomplished in 7 computation periods. The more bits simultaneously involving in the parallel operations in the hardware, the more advantages the disclosed method can provide.

The above descried in detail the method for training the neural network. Next, a device for training the neural network, a computer system, and a movable device will be described below. It should be understood that the device for training the neural network, the computer system, and the movable device may perform the various methods described above. That is, the detailed operation processes of the various products can refer to the descriptions of the corresponding processes of the disclosed methods.

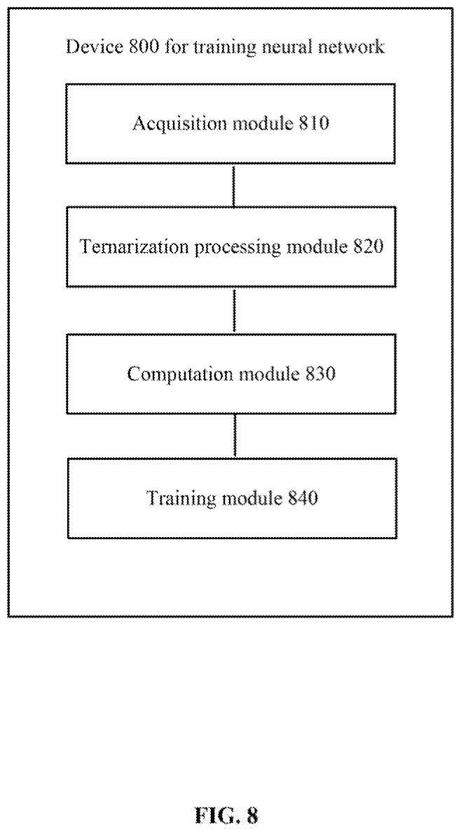

FIG. 8 is a schematic diagram of a device 800 for training a neural network. As shown in FIG. 8, the device 800 may include:

an acquisition module 810, e.g., an acquisition circuit, configured to obtain a set of first weights of a processing unit of the neural network, where the processing unit of the neural network is a convolution core or a neuron;

a ternarization processing module 820, e.g., a ternarization processing circuit, configured to ternarizing each weight included in the set of first weights to obtain a set of second weights;

a computation module 830, e.g., a computation circuit, configured to generate an output of the processing unit based on the set of second weights and a set of inputs of the processing unit. The set of inputs of the processing unit of a latter layer of the neural network may be obtained from the output of the processing unit of a preceding layer;

a training module 840, e.g., a training circuit, configured to train the weights included in the set of first weights of each processing unit of the neural network based on the error cost function. The error cost function may include an error term and a structurally sparse term. The error term may relate to an error between an output of the last layer of the neural network and an expected output. The structurally sparse term may render all of the weights included in the set of first weights of some processing units of the neural network to be zero.

In some embodiments, the ternarization processing module 820 may be configured to:

if the first weight is in a predetermined range, ternarize the first weight to be zero, where the first weight is a weight included in the set of first weights;

if the first weight is greater than the predetermined range, ternarize the first weight to be 1;

if the first weight is smaller than the predetermined range, ternarize the first weight to be −1.

In some embodiments, the computation module 830 may be configured to:

obtain a response value based on a set of second weights and a set of inputs of the processing unit; and

binarize the response value to obtain an output of the processing unit.

In some embodiments, the computation module 830 may be configured to:

perform an inner product between a vector corresponding to the set of second weights and a vector corresponding to the set of inputs of the processing unit to obtain the response value.

In some embodiments, the computation module 830 may be configured to perform a batch normalization on the response value prior to binarizing the response value.

In some embodiments, the computation module 830 may be configured to:

if the response value is greater than a predetermined value, process the output of the processing unit to be 1;

if the response value is not greater than the predetermined value, process the output of the processing unit to be 0.

In some embodiments, the training module 840 may be configured to:

adjust the weights included in the set of first weights of each processing unit of the neural network to render the cost of the error cost function to reach a predetermined cost or to be minimized.

In some embodiments, the training module 840 may be configured to:

determine a derivative of the error cost function with respect to the second weight;

adjust the first weight based on the derivative, where the first weight is a weight from the set of first weights, and the second weight is a ternarized value of the first weight prior to the current adjustment.

In some embodiments, the training module 840 may be configured to:

determine the derivative based on an activation function that has been binarized.

It should be understood that the device for training the neural network may be a chip, which may be realized by circuits. The present disclosure does not limit the form for realizing the device.

The present disclosure also provides a processor. The processor may include the device for training the neural network according to various embodiments disclosed herein.

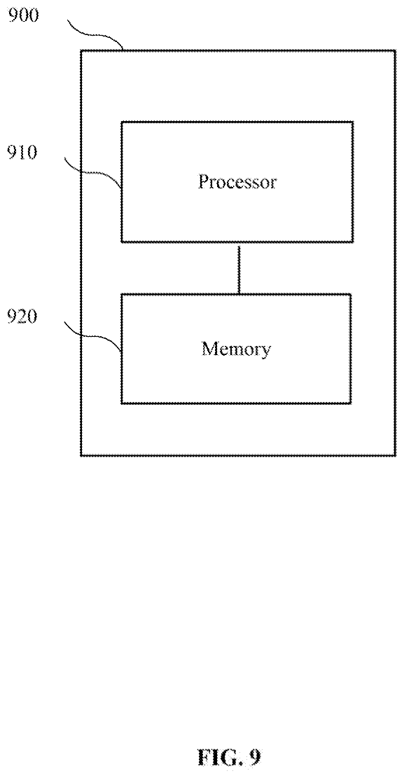

FIG. 9 is a schematic diagram of a computer system 900 according to an embodiment of the present disclosure.

As shown in FIG. 9, the computer system 900 may include a processor 910 and a memory 920.

It should be understood that the computer system 900 may include other components that are typically included in other computer systems, such as an input/output device, a communication interface, etc., which are not limited by the present disclosure.

The memory 920 may be configured to store computer-executable instructions.

The memory 920 may be any suitable type of memory, such as a high speed random access memory (“RAM”), a non-volatile memory, such as a magnetic disk, which is not limited by the present disclosure.

The processor 910 may be configured to access the memory 920, and to execute the computer-executable instructions to perform various operations of the disclosed methods for training the neural network, according to various disclosed embodiments.

The processor 910 may include a microprocessor, a field-programmable gate array (“FPGA”), a central processing unit (“CPU”), a graphics processing unit (“GPU”), etc., which is not limited by the present disclosure.

The present disclosure also provides a movable device, which may include the device for training neural network, the processor, or the computer system disclosed in the above various embodiments.

The device for training neural network, the computer system, and the movable device may correspond to the execution entities for executing the methods for training the neural network. In addition, the above and other operations and/or functions of various modules of the device for training neural network, the computer system, and the movable device are for realizing the corresponding processes of the various methods. For simplicity, such operations and/or functions are not repeated.

The present disclosure also provides a computer storage medium. The computer storage medium may be configured to store program codes. The program codes may be configured to execute the methods disclosed herein for training neural network.

It should be understood that in the present disclosure, the term “and/or” describes only a relationship between related objects, indicating that three relationships may exist. For example, A and/or B may represent three situations: A only, A and B, and B only. The term “and/or” may be interpreted as “at least one of.” In addition, the symbol “/” indicates that an “or” relationship between related objects.

A person having ordinary skills in the art can appreciate, the units and algorithm steps of various examples described in the present disclosure may be realized using electrical hardware, computer software, or a combination thereof. To clearly describe the exchangeability between the hardware and software, the components and steps of various examples have been generally described based on functions. Whether the functions are executed by hardware or software depends on the specific application of the technical solution and design constraints. A person having ordinary skills in the art can use different methods to realize the described functions for each specific application. Such implementations are not deemed to be beyond the scope of the present disclosure.

A person having ordinary skills in the art can appreciate that for simplicity and convenience of descriptions, the detailed operations of the above-described system, device, and unit can refer to the corresponding processes in the above-described methods, which are not repeated.

In the embodiments provided in the present disclosure, it should be understood that the disclosed system, device, and method can be realized through other manners. For example, the device embodiments described above are only illustrative. The separation of units is only a separation based on logic functions. In actual implementations, the separation of units may be based on other separation manners. For example, multiple units or components may be combined or may be integrated into another system, or some features may be ignored or may not be executed. In addition, the coupling, direct coupling, or communicative connection displayed or described may be indirect coupling or communicative connection through some interfaces, devices, or units. The coupling or communicative connection may be electrical, mechanical, or any other forms of connection.

In the descriptions, when a unit or component is described as a separate unit or component, the separation may or may not be physical separation. The unit or component may or may not be a physical unit or component. The separate units or components may be located at a same place, or may be distributed at various nodes of a grid or network. The actual configuration or distribution of the units or components may be selected or designed based on actual need of applications.

Various functional units or components may be integrated in a single processing unit, or may exist as separate physical units or components. In some embodiments, two or more units or components may be integrated in a single unit or component. The integrated unit may be realized using hardware or a combination of hardware and software.

If the integrated units are realized as software functional units and sold or used as independent products, the integrated units may be stored in a computer-readable storage medium. Based on such understanding, the portion of the technical solution of the present disclosure that contributes to the current technology, or some or all of the disclosed technical solution may be implemented as a software product. The computer software product may be stored in a non-transitory storage medium, including instructions or codes for causing a computing device (e.g., personal computer, server, or network device, etc.) to execute some or all of the steps of the disclosed methods. The storage medium may include any suitable medium that can store program codes or instruction, such as at least one of a U disk (e.g., flash memory disk), a mobile hard disk, a read-only memory (“ROM”), a random access memory (“RAM”), a magnetic disk, or an optical disc.

The above described various embodiments of the present disclosure. The scope of protection of the present disclosure is not limited to the described embodiments. A person having ordinary skills in the art can conceive other equivalent modification or replacement within the technical scope of the present disclosure. Such modification or replacement should fall within the scope of protection of the present disclosure. As such, the scope of protection of the present disclosure should refer to the scope of protection defined by the following claims.

What is claimed is:

1. An aircraft, comprising:
a propulsion system configured to provide propulsion for the aircraft;
a control system configured to control movement of the aircraft;
a processing system including a memory and a processor, wherein the memory is configured to store computer-executable instructions, the processor is configured to access the memory and to execute the computer-executable instructions to perform the following steps:
obtaining a set of first weights of a processing unit of a neural network, the processing unit being a convolution core or a neuron;
ternarizing each weight included in the set of first weights to obtain a set of second weights;
generating an output of the processing unit based on the set of second weights and a set of inputs of the processing unit; and
training weights included in the set of first weights of the processing unit of the neural network based on an error cost function, wherein the error cost function includes an error term and a structurally sparse term, the error term relates to an error between an output of a last layer of the neural network and an expected output, and the structurally sparse term renders all weights included in the set of first weights of at least one processing unit of the neural network to be zero.

2. The aircraft of claim 1, wherein the processor is also configured to perform the following steps:
if a first weight is within a predetermined range, ternarizing the first weight to be zero, wherein the first weight is a weight included in the set of first weights;
if the first weight is greater than the predetermined range, ternarizing the first weight to be 1; and
if the first weight is smaller than the predetermined range, ternarizing the first weight to be −1.

3. The aircraft of claim 1, wherein when the processor generates the output of the processing unit based on the set of second weights and the set of inputs of the processing unit, the processor is also configured to perform the following steps:
obtaining a response value based on the set of second weights and the set of inputs of the processing unit; and
binarizing the response value to obtain the output of the processing unit.

4. The aircraft of claim 3, wherein the processor obtains the response value based on the set of second weights and the set of inputs of the processing unit, the processor is also configured to perform the following step:
performing an inner product between a vector corresponding to the set of second weights and a vector corresponding to the set of inputs of the processing unit to obtain the response value.

5. The aircraft of claim 3, wherein prior to binarizing the response value, the processor is also configured to perform the following step:
performing a batch normalization on the response value.

6. The aircraft of claim 3, wherein when the processor binarizes the response value, the processor is also configured to perform the following steps:
if the response value is greater than a predetermine value, processing the output of the processing unit to be 1; and
if the response value is not greater than the predetermined value, processing the output of the processing unit to be 0.

7. The aircraft of claim 1, wherein when the processor trains the weights included in the set of first weights of the processing unit of the neural network based on the error cost function, the processor is also configured to perform the following step:
adjusting the weights included in the set of first weights of the processing unit of the neural network to render a cost of the error cost function to reach a predetermined cost or to be minimized.

8. The aircraft of claim 7, wherein when the processor adjusts the weights included in the set of first weights of the processing unit of the neural network, the one or multiple processors are also configured to perform the following steps:
determining a derivative of the error cost function with respect to a second weight; and
adjusting a first weight based on the derivative, wherein the first weight is a weight in the set of first weights, and the second weight is a ternarized value of the first weight prior to the adjustment.

9. The aircraft of claim 8, wherein when the one or multiple processors determine the derivative of the error function with respect to the second weight, the one or multiple processors are configured to perform the following step:
determining the derivative based on an activation function that not been binarized.

10. A method for training a neural network, comprising:
obtaining a set of first weights of a processing unit of the neural network, wherein the processing unit of the neural network is a convolution core or a neuron;
ternarizing each weight in the set of first weights to obtain a set of second weights;
generating an output of the processing unit based on the set of second weights and a set of inputs of the processing unit; and
training weights included in the set of first weights of the processing unit of the neural network based on an error cost function, wherein the error cost function includes an error term and a structurally sparse term, the error term relates to an error between an output of a last layer of the neural network and an expected output, and the structurally sparse term renders all weights in the set of first weights of at least one processing unit of the neural network to be zero.

11. The method of claim 10, wherein ternarizing each weight in the set of first weights comprises:
if a first weight is within a predetermined range, ternarizing the first weight to be zero, wherein the first weight is a weight in the set of first weights;
if the first weight is greater than the predetermined range, ternarizing the first weight to be 1; and
if the first weight is smaller than the predetermined range, ternarizing the first weight to be −1.

12. The method of claim 10, wherein generating the output of the processing unit based on the set of second weights and the set of inputs of the processing unit comprises:
obtaining a response value based on the set of second weights and the set of inputs of the processing unit; and
binarizing the response value to obtain the output of the processing unit.

13. The method of claim 12, wherein obtaining the response value based on the set of second weights and the set of inputs of the processing unit comprises:
performing an inner product between a vector corresponding to the set of second weights and the set of inputs of the processing unit to obtain the response value.

14. The method of claim 12, further comprising:
prior to binarizing the response value, performing a batch normalization on the response value.

15. The method of claim 12, wherein binarizing the response value comprises:
if the response value is greater than a predetermined value, processing the output of the processing unit to be 1; and
if the response value is not greater than the predetermined value, processing the output of the processing unit to be 0.

16. The method of claim 10, wherein training weights included in the set of first weights of the processing unit of the neural network based on the error cost function comprises:
adjusting the weights included in the set of first weights of the processing unit of the neural network to render a cost of the error cost function to reach a predetermined cost or is minimized.

17. The method of claim 16, wherein adjusting the weights included in the set of first weights of the processing unit of the neural network comprises:
determining a derivative of the error cost function with respect to a second weight; and
adjusting a first weight based on the derivative, wherein the first weight is a weight in the set of first weights, and the second weight is a ternarized value of the first weight prior to the adjustment.

18. The method of claim 17, wherein determining the derivative of the error cost function with respect to the second weight comprises:
determining the derivative based on an activation function that not been binarized.

19. A movable device, comprising:
a memory configured to store computer-executable instructions; and
a processor configured to access the memory and to execute the computer-executable instructions to perform the following steps:
obtaining a set of first weights of a processing unit of a neural network, the processing unit being a convolution core or a neuron;
ternarizing each weight included in the set of first weights to obtain a set of second weights;
generating an output of the processing unit based on the set of second weights and a set of inputs of the processing unit; and
training weights included in the set of first weights of the processing unit of the neural network based on an error cost function, wherein the error cost function includes an error term and a structurally sparse term, the error term relates to an error between an output of a last layer of the neural network and an expected output, and the structurally sparse term renders all weights included in the set of first weights of at least one processing unit of the neural network to be zero.

20. The movable device of claim 19, wherein the processor is also configured to perform the following steps:
if a first weight is within a predetermined range, ternarizing the first weight to be zero, wherein the first weight is a weight included in the set of first weights;
if the first weight is greater than the predetermined range, ternarizing the first weight to be 1; and
if the first weight is smaller than the predetermined range, ternarizing the first weight to be −1.
